(19) United States
(12) Patent Application Publication
(10) Pub. No.: US 2014/0212124 A1
(43) Pub. Date: Jul. 31, 2014

(54) CAMERA

(71) Applicant: Ingrasys Technology Inc., Taoyuan (TW)

(72) Inventor: SHU-YUN HUANG, Taoyuan (TW)

(73) Assignee: INGRASYS TECHNOLOGY INC., Taoyuan (TW)

(21) Appl. No.: 14/163,517

(22) Filed: Jan. 24, 2014

(30) Foreign Application Priority Data
Jan. 29, 2013 (TW) 102103346

(51) Int. Cl. G03B 17/12

(52) U.S. Cl. CPC G03B 17/12
USPC 396/529

(57) ABSTRACT

A camera includes a cover, an outer frame rotatably connected to the cover about a first axis, a mounting bracket rotatably connected to the outer frame about a second axis perpendicular to the first axis, and a lens module rotatably connected to the mounting bracket about a third axis coaxial with the first axis.

### FIELD

The present disclosure relates to a camera.

### BACKGROUND

A lens of a camera is in need to be rotated to different directions, to align with the object. Therefore, the rotation structure of the camera is generally sophisticated, which makes the assembly of the rotation structure troublesome.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a camera, wherein the camera comprises an outer frame.

FIG. 2 is an inverted view of the outer frame of FIG. 1.

FIG. 3 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

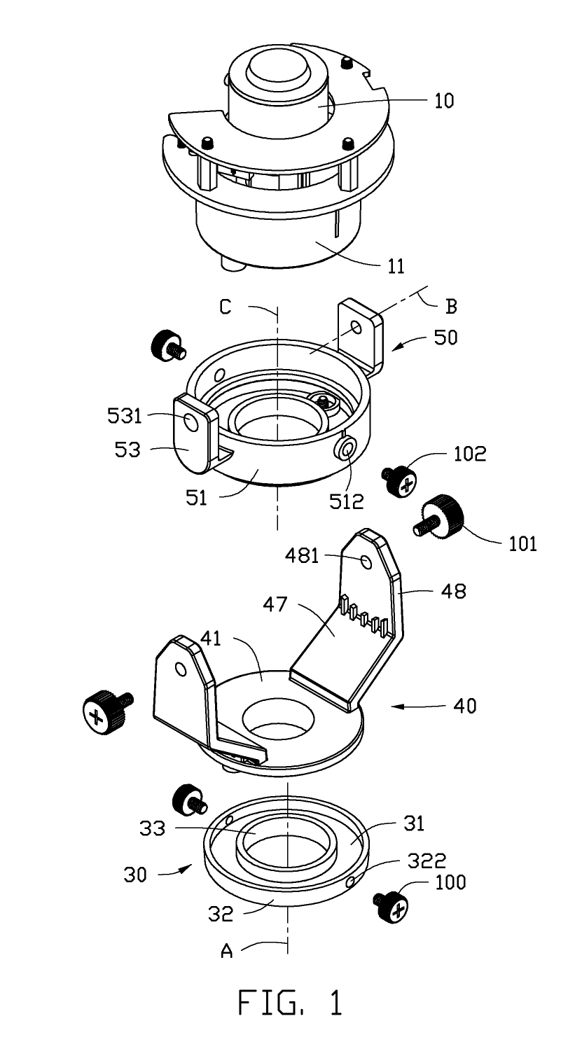

FIG. 1 shows an exemplary embodiment of a camera. The camera comprises a lens module 10, a cover 30, an outer frame 40, and a mounting bracket 50. The lens module 10 comprises a housing 11 located at a lower portion of the lens module 10.

The cover 30 comprises an annular base plate 31, a first flange 32 perpendicularly extending from an outer edge of the base plate 31, and a second flange 33 perpendicularly extending from an inner edge of the base plate 31. The first flange 32 contains two opposite screw holes 322 defined therein.

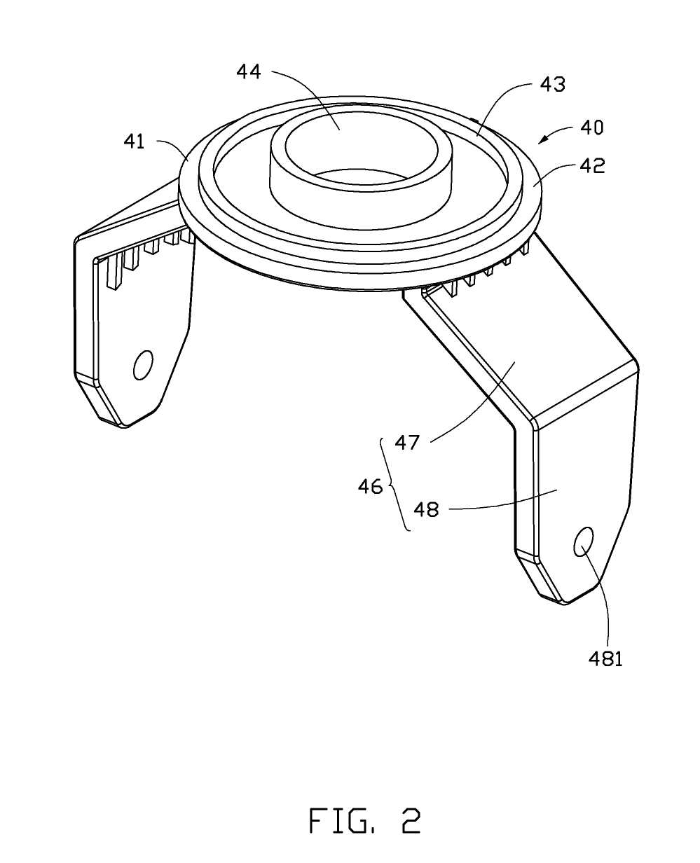

FIG. 2 shows the outer frame 40 comprising a base body 41 and two opposite connection portions 46. The base body 41 comprises a circular base wall 42, an annular first sidewall 43 perpendicularly extending from a first surface of the base wall 42, and an annular second sidewall 44 perpendicularly extending from the first surface of the base wall 42 and enclosed by the first sidewall 43. The base wall 42, the first sidewall 43, and the second sidewall 44 are concentric. Each connection portion 46 comprises an extension plate 47 slantingly extending from a second surface of the base wall 42 opposite to the first surface, and a connection plate 48 extending from a distal end of the extension plate 47 opposite to the base wall 42. Each connection plate 48 is perpendicular to the base wall 42, and contains a through hole 481 defined therein.

As shown in FIG. 1, the mounting bracket 50 comprises an annular receiving portion 51, and two opposite L-shaped pivot arms 53 extending from a circumference of the receiving portion 51. The receiving portion 51 defines two opposite screw holes 512. Each pivot arm 53 contains a position hole 531 defined therein.

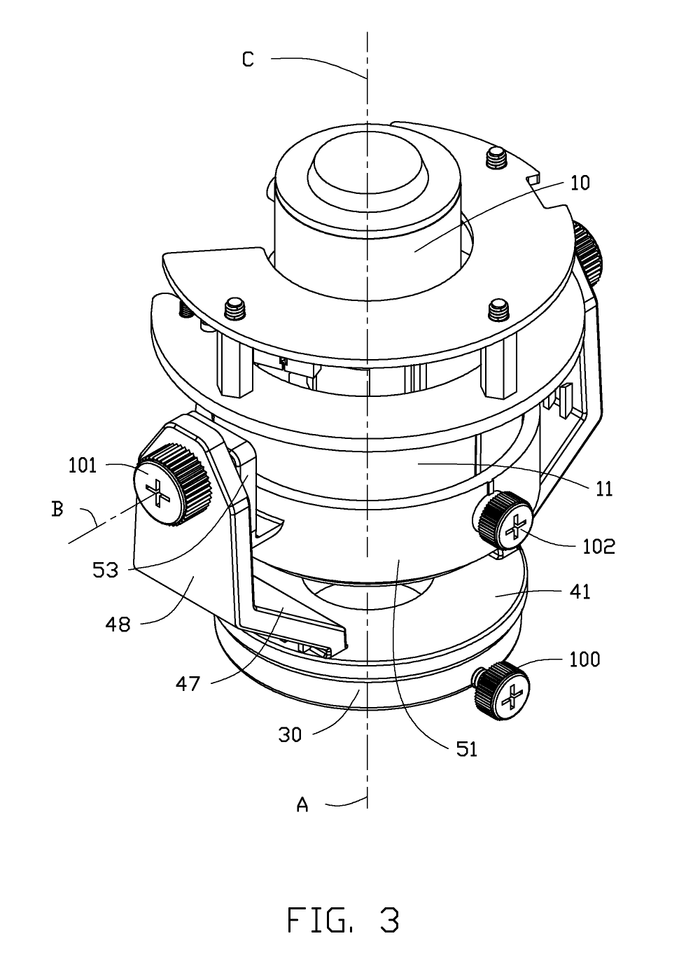

Referring to FIGS. 1-3, the second sidewall 44 extends into the second flange 33 and abuts against an inner surface of the second flange 33. The first sidewall 43 extends into the first flange 32 and abuts against an inner surface of the first flange 32. The outer frame 40 can rotate relative to the cover 30 about a first axis A, wherein the first axis A is a center axis of the cover 30 and the base body 41. Two fasteners 100 extend through the screw holes 322 and abut against an outer surface of the first sidewall 43, to fasten the outer frame 40 to the cover 30. The mounting bracket 50 is placed between the connection plates 48. Two fasteners 101 extend through the through holes 481, and engage in the position holes 531, to fasten the mounting bracket 50 to the outer frame 40. When the fasteners 101 are released, the mounting bracket 50 can rotate relative to the outer frame 40 about a second axis B, wherein the second axis B is a center axis of the through holes 481 and the position holes 531. The second axis B is perpendicular to the first axis A. The lens module 10 is placed into the receiving portion 51. The housing 11 of the lens module 10 abuts against an inner surface of the receiving portion 51. The lens module 10 can rotate relative to the mounting bracket 50 about a third axis C. The third axis C is a center axis of the receiving portion 51, and is coaxial with the first axis A. Two fasteners 102 extend through the screw holes 512, and abut against the housing 11, to fasten the lens module 10 to the mounting bracket 50.

Through the rotation of the outer frame 40 relative to the cover 30, the rotation of the mounting bracket 50 relative to the outer frame 40, and the rotation of the lens module 10 relative to the mounting bracket 50, the lens module 10 can be adjusted to different directions. The structure of the camera is simple, and elements of the camera can be assembled quickly.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A camera, comprising:
a cover;
an outer frame rotatably connected to the cover about a first axis;
a mounting bracket rotatably connected to the outer frame about a second axis perpendicular to the first axis; and
a lens module rotatably connected to the mounting bracket about a third axis coaxial with the first axis.

2. The camera of claim 1, wherein the outer frame comprises a base body, and two opposite connection portions extending from the base body, the base body is rotatably connected to the cover, the mounting bracket is rotatably connected between the connection portions.

3. The camera of claim 2, wherein the cover comprises an annular base plate, and a first flange extending from an outer edge of the base plate, the base body comprises a base wall, and an annular first sidewall extending from the base wall, the first sidewall is rotatably received in the first flange, the first axis is a center axis of the first flange and the first sidewall.

4. The camera of claim 3, wherein the first flange defines two opposite screw holes, two fasteners extend through the screw holes and abut against the first sidewall, to fasten the outer frame to the cover.

5. The camera of claim 3, wherein the cover further comprises a second flange extending from an inner edge of the base plate, the base body further comprises a second sidewall extending from the base wall and enclosed by the first sidewall, the second sidewall is rotatably received in the second flange.

6. The camera of claim 2, wherein the mounting bracket comprises two opposite pivot arms, the pivot arms are rotatably connected to the connection portions.

7. The camera of claim 6, wherein each connection portion defines a through hole, each pivot arm defines a position hole, two fasteners extend through the through holes and engage in the position holes, the second axis is a center axis of the through holes and the position holes.

8. The camera of claim 6, wherein each connection portion comprises an extension plate slantingly extending from the base body, and a connection plate extending from a distal end of the extension plate and perpendicular to the base body, the pivot arms are rotatably connected to the connection plates.

9. The camera of claim 6, wherein the mounting bracket comprises an annular receiving portion, the pivot arms extending from a circumference of the receiving portion, the lens module is rotatably received in the receiving portion, the third axis is a center axis of the receiving portion.

10. The camera of claim 9, wherein the receiving portion defines two opposite screw holes, the lens module comprises a housing, two fasteners extend through the screw holes and abut against the housing, to fasten the lens module to the mounting bracket.
